(19) United States
(12) Patent Application Publication
(10) Pub. No.: US 2023/0278182 A1
(43) Pub. Date: Sep. 7, 2023

(54) Hand-Held Power Tool, Tool and Hand-Held Power Tool System Having a Designated Ratio of Rotational Speed to Impact Frequency

(71) Applicant: Hilti Aktiengesellschaft, Schaan (LI)

(72) Inventors: Maximilian KNYRIM, Ehingen (DE); Markus HARTMANN, Mauerstetten (DE); Bastian PLÜMACHER, Landsberg am Lech (DE); Olaf KOCH, Kaufering (DE)

(21) Appl. No.: 18/005,427

(22) PCT Filed: Feb. 22, 2021
(86) PCT No.: PCT/EP2021/054285

§ 371 Date: Jan. 13, 2023

(30) Foreign Application Priority Data
Jul. 17, 2020 (EP) 20186377.6

(51) Int. Cl. B25D 11/06; B25D 16/00; B25D 17/22

(52) U.S. Cl. CPC B25D 11/06; B25D 16/00; B25D 17/22; B25D 2211/06; B25D 2250/095; B25D 2250/181

(57) ABSTRACT

A hand-held power tool includes a tool fitting, an impact mechanism, and a rotary drive. The hand-held power tool is configured to rotate a tool held in the tool fitting with a rotational speed about a longitudinal axis of the tool and to drive the tool with an impact movement along the longitudinal axis at an impact frequency f. A ratio of the rotational speed to the impact frequency f at least at a working point of the hand-held power tool is at most 5.0 rpm/Hz or at least at the working point of the hand-held power tool the rotational speed is at most (0.2*(f/Hz-22)\hat{ }2+80) rpm for impact frequencies f in a range from 20 to 60 Hz.

### BACKGROUND AND SUMMARY OF THE INVENTION

The invention relates to a hand-held power tool, in particular a hammer drill, with a tool fitting, an impact mechanism and a rotary drive, wherein the hand-held power tool is configured to rotate a tool held in the tool fitting with a rotational speed n about a longitudinal axis of the tool and to drive the tool with an impact movement along the longitudinal axis at an impact frequency f, wherein the impact mechanism is in the form of a direct electromechanical, electropneumatic or electromagnetic impact mechanism. The invention furthermore relates to a tool and to a hand-held power tool system.

The contents of the descriptions, the claims and the drawings of European applications EP19192219A of 2019 Aug. 19, EP19193854 of 2019 Aug. 27 and EP19195363A of 2019 Sep. 4 are expressly incorporated by reference herein.

For ecological reasons as well as for cost reasons, there is a particular need for particularly effectively and efficiently working hand-held power tools, for example hammer drills, associated tools and, in particular, a hand-held power tool and a tool for hand-held tool systems having the hand-held power tool.

In order to meet this need, it is therefore an object of the present invention to provide hand-held power tools, tools and hand-held power tool systems of the generic type that can be operated with particularly high efficiency.

This object is achieved by a hand-held power tool, in particular a hammer drill, with a tool fitting, an impact mechanism and a rotary drive, wherein the hand-held power tool is configured to rotate a tool held in the tool fitting with a rotational speed n about a longitudinal axis of the tool and to drive the tool with an impact movement along the longitudinal axis at an impact frequency f, wherein the impact mechanism is in the form of a direct electromechanical, electropneumatic or electromagnetic impact mechanism, wherein the ratio of the rotational speed n to the impact frequency f at least at one working point of the hand-held power tool is at most 5.0 rpm/Hz, or wherein, at least at the working point of the hand-held power tool, the rotational speed n is at most (0.2*(f/Hz-22)\hat{ }2+80) rpm depending on the impact frequency f, in particular for impact frequencies f in the range from 20 to 60 Hz.

A hand-held power tool can achieve particularly low friction losses if the ratio of the rotational speed n to the impact frequency f at least at the working point of the hand-held power tool is at most 4.0 rpm/Hz, particularly preferably at most 3.0 rpm/Hz.

The working point can correspond to a hammer drill operation of the hand-held power tool. In particular, it can correspond to a full load operation of the hand-held power tool. As an alternative or in addition, the working point can correspond to an operating state with a device-related highest possible impact frequency for a highest possible rotational frequency n.

The hand-held power tool can be configured in particular for processing natural or artificial rocks, for example masonry and/or cement-containing rocks.

For delimitation from, for example, pure chiseling machines, the rotational speed at the working point can be at least 1 rpm or, depending on the impact frequency f, at least f/Hz*0.1 rpm, preferably at least f/Hz*2 rpm.

As an alternative or in addition, an indexing angle, i.e., the angle by which the tool is offset between two impacts, can be at least 15, preferably at least 20 degrees, at least at the working point.

As an alternative or in addition, the rotational speed n can be at least half of the abovementioned maximum values depending on the impact frequency f.

The invention is based on the concept of being able to crush such rocks, for example in order to form a borehole, customarily primarily by means of the impact movement. In particular, the crushing can be undertaken by means of a tool tip of a tool held in the tool fitting, for example a rock drill, in the form of rhythmic impact, that is to say chiseling.

During the crushing, the parallel rotational movement usually has the purpose of rotating and/or displacing the tool tip such that the crushing can take place over a certain processing area, i.e., not just at a single point. In addition, the rotational movement—at least in the case of tools with a helical structure formed along their longitudinal axis, such as, for example, in the case of rock twist drills—is required for conveying cuttings produced at the tool tip.

However, with increasing rotational speeds n there are considerable, sometimes disproportionately increasing, friction losses.

Considerable energy savings can thus be achieved if the hand-held power tool, as provided according to the invention, executes a rotational movement that is slow in relation to the impact frequency, at least at the working point. However, the rotational movement at the working point is preferably nevertheless so fast that a sufficient rotary offset of the tool can take place between two impacts. Depending on the type of tool used, the rotational speed can also be selected depending on a required cuttings conveying speed, in particular if there is a structurally determined relationship between them.

Tool damage and/or damage to the rock being processed due to overheating because of friction and heat can also be avoided by the invention. Work safety can also be increased.

The invention is thus furthermore based on the surprising finding that hand-held power tools permitting a combination of an impact movement with a rotational movement at least at the working point can be improved by selecting and/or setting the ratio between the rotational speed n and the impact frequency f at least at the working point.

In the case of a hand-held power tool having different operating modes, for example a pure rotational movement mode or drilling mode and a hammer drill mode corresponding to the working point, it is therefore conceivable to configure the hand-held power tool in such a way that, by changing into the hammer drill mode or on reaching the working point, the rotational speed n is limited at most to the maximum values according to the invention and, on leaving the hammer drill mode or the working point, this limitation is lifted and/or the maximum value of the rotational speed n is set to a higher value.

The hand-held power tool can have a tool recognition device for identifying a type of a tool used in the tool fitting. As an alternative or in addition, the type of the tool used in the tool fitting can also be settable by a user of the hand-held power tool.

The hand-held power tool can also be configured, depending on the type of tool, preferably at least at the working point, to limit the rotational speed n to a maximum value that preferably corresponds at most to the maximum values according to the invention, and/or to a minimum value. For example, in the case of a tool in the form of a suction drill or a hollow drill, a particularly low maximum value of the rotational speed n can be set, whereas in the case of a tool having a helical structure, a slightly higher maximum value, but preferably nevertheless at most corresponding to the maximum values according to the invention, is set.

The hand-held power tool can in particular be configured to vary the value or the maximum value of the ratio between the rotational speed n and the impact frequency f at different impact frequencies f and/or within different frequency ranges of the impact frequency f, in particular also taking into account the type of tool used. This is based on the concept that, at very low frequencies, for example, a minimum rotational speed n can be ensured by this variation. At least in the case of individual types of tool, the increase in friction due to the rotational movement can be less than a third power, and therefore relatively higher rotational speeds n can also be used relative to the impact frequency f.

For this purpose, too, and in general for reasons of the range of adjustability of the hand-held power tool, it is advantageous if the hand-held power tool has a multi-stage transmission.

The hand-held power tool can be configured to control a transmission on the basis of, or at least taking into consideration, the determined or set type of received tool, in particular to select one of the transmission stages of a multi-stage transmission in dependence thereon. As an alternative or in addition, in the case of hand-held power tools having at least two drive units, a ratio of the speeds of the two drive units to one another can also be set or settable, in particular in dependence on the set or determined type of received tool.

Overall, the ratio of the rotational speed n to the impact frequency f can have a U-shaped or at least substantially U-shaped profile beyond the frequency range used for the impact frequency f.

If the overall available power of the hand-held power tool is limited, this also makes it possible to direct a larger proportion of the overall power to the impact movement such that the propulsion achieved in the rock can be increased with the same overall power. As an alternative or in addition, the overall power used can also be reduced while maintaining the propulsion achieved.

An electric impact mechanism can be understood to be electromechanically operating impact mechanisms, in particular with a rotation-generating drive, for example cam impact mechanisms or ratchet impact mechanisms, electropneumatic impact mechanisms, that is to say impact mechanisms containing an air chamber for the transmission and/or transformation of the impact movement, as well as electromagnetic impact mechanisms, for example based on the principle of a railgun and/or impact mechanisms having a linear motor. The impact mechanism can be a direct impact mechanism, that is to say with a drive that is free of rotational movement, or an indirect impact mechanism, that is to say with a drive based on a rotational movement.

The hand-held power tool can have at most one drive unit, in particular a motor, for driving the impact mechanism and the rotary drive. In other words, the impact mechanism and the rotary drive can be driven by means of a common drive unit. Alternatively, a separate drive, in particular by means of at least two drive units, is also conceivable. The rotational speed n and/or the impact frequency f or the ratio thereof with respect to each other can be defined or definable in a device-related manner. For example, at the working point, one or more transmissions of the hand-held power tool can be selected by the hand-held power tool automatically during use and/or. The transmission or the transmissions can have transmission ratios tailored to the working point.

If the hand-held power tool has a pneumatic, in particular an electropneumatic, cuttings conveying device, particularly low rotational speeds n can be used, since cuttings can be conveyed by the cuttings conveying device. The cuttings conveying device can be or can have a suction device.

The increases in effectiveness and efficiency achieved according to the invention are particularly useful when the hand-held power tool is in the form of a portable device. The hand-held power tool can in particular weigh at most 25 kg. The power output by the impact mechanism can be limited to at most 2 kW, particularly preferably to at most 1 kW.

The hand-held power tool can particularly preferably be operated cordlessly. It can preferably have a battery, in particular a lithium-containing battery. The hand-held power tool can, for example, have a portable power storage device, for example a rechargeable battery. The increases in effectiveness and efficiency achieved according to the invention make it possible to achieve particularly long running times with a single battery charge.

According to the invention, the transmission or the transmissions can have particularly high reduction ratios, for example 50:1. Hand-held power tools are therefore particularly preferred which comprise at least one overrunning clutch, a gate-type transmission or a circular thrust transmission. For example, combinations of the overrunning clutch with the gate-type transmission and/or the circular thrust transmission are also conceivable. Further details according to the invention relating to particularly advantageous refinements of the overrunning clutch, the gate-type transmission and the circular thrust transmission are found in the European patent applications mentioned at the beginning and incorporated by reference as part of this description.

In the case of a tool having a helical structure for a hand-held power tool according to the invention, the gradient of the helical structure can be increased compared to known helical structures, in particular of tools for processing rocks.

The scope of the invention also includes a tool for a hand-held power tool according to the invention, comprising a tool tip, a tool shaft and a shank for holding the tool in the tool fitting of the hand-held power tool, wherein a material transport channel is formed at least along the tool shaft, wherein the material transport channel has a minimum cross-sectional area of 19 mm² or at least 6%, particularly preferably at least 12%, of the cross-sectional area of the borehole which can be produced by the tool. In particular when working at comparatively low rotational speeds n, larger cuttings particles can increasingly arise, which can also be safely transported away owing to the comparatively large material transport channel. Clogging of the tool can thus be avoided even at rotational speeds n which are low in relation to the impact frequency f.

In general, the tool can be in the form of a hollow drill.

Such a tool enables particularly powerful drilling cuttings to be conveyed either through the material transport channel or by a flushing fluid, which is preferably conveyed to the tool tip via the material transport channel, so that cuttings can be flushed away from the tool tip for removal.

In general, the tool and/or the hand-held power tool can be configured to convey the cuttings mechanically, pneumatically or hydraulically.

In particular, the tool can be in the form of a suction drill for this purpose. The drilling conveyor device can have a suction device, in particular adapted to the tool.

The scope of the invention also includes use of a tool according to the invention for working natural or artificial rock.

The object is also achieved by a hand-held power tool system comprising a hand-held power tool according to the invention and a tool according to the invention.

The hand-held power tool system can be configured for processing natural or artificial rocks.

Further features and advantages of the invention emerge from the following detailed description of exemplary embodiments of the invention, with reference to the drawing, which shows details essential to the invention, from the claims and from the description and the drawing, which also shows details essential to the invention, by reference to incorporated European patent applications mentioned at the beginning. The features shown there are not necessarily to be understood as true to scale and are shown in such a way that the special features according to the invention can be made clearly visible. The various features can be implemented individually or collectively in any combination in variants of the invention.

In the schematic drawing, exemplary embodiments of the invention are shown and explained in more detail in the following description.

### BRIEF DESCRIPTION OF THE DRAWING

The FIGURE shows a hand-held power tool system of the present invention.

### DETAILED DESCRIPTION OF THE DRAWING

A hand-held power tool system 10 has a hand-held power tool 12. The hand-held power tool 12 can be operated cordlessly. For this purpose, it has a rechargeable battery 14. It is in the form of a portable device.

It also has a tool fitting 16.

A tool 18 is received in the tool fitting. For this purpose, the tool 18 has a tool shaft 20, at one end of which a shank 22 is formed and at the other end of which a tool tip 24 is formed.

The tool 18 is in the form of a hollow drill and in particular a suction drill. For this purpose, it has a material transport channel 26, which runs inside the tool shaft 20 and is shown schematically in the FIGURE, via which cuttings extracted from the vicinity of the tool tip 24 can be conveyed to a cuttings conveying device 28.

The material transport channel 26 has a cross-sectional area of 15% of the cross section of a borehole to be created by the tool 18.

Furthermore, the hand-held power tool 12 has an operating mode selector switch 30 for switching between different operating modes, in particular for switching between a pure drilling mode, a pure chiseling mode and a hammer drill mode. In the position shown of the operating mode selector switch 30, the hammer drill mode is selected. The hand-held power tool 12 can be set in motion by means of an actuating lever 31 and, in particular, operated at a working point with a device-related highest possible rotational speed.

The hand-held power tool 12 also has an electropneumatic impact mechanism 32 and a rotary drive 34. The impact mechanism 32 and the rotary drive 34 are driven by a common drive unit 36, an electric motor. The hand-held power tool 12 is configured to rotate the tool 18 held in the tool fitting 16 at a rotational speed n about a longitudinal axis L of the tool 18 and to drive the tool with an impact movement along the longitudinal axis L at an impact frequency f.

In this exemplary embodiment, the ratio of the rotational speed n to the impact frequency f at the working point is 4.0 rpm/Hz.

In alternative exemplary embodiments A2, A3, A4, A5 and A6, which can be constructed in principle, in particular structurally identically, to the exemplary embodiment described above, this ratio depends on the impact frequency f at the respective working point, in these exemplary embodiments with impact frequencies f in the range from 20 to 60 Hz, as can be seen from Table 1 below. However, the rotational speed n does not exceed (0.2*(f/Hz-22)\hat{ }2+80) rpm.

TABLE 1

| | Impact | Rotational | Ratio Rotational speed |
|---|---|---|---|
| | frequency f at | speed n at | n to impact frequency |
| Exemplary | the working | the working | f at the working |
| embodiment | point (Hz) | point (rpm) | point (rpm/Hz) |
| A2 | 20 | 80 | 4 |
| A3 | 30 | 90 | 3 |
| A4 | 40 | 120 | 3 |
| A5 | 50 | 200 | 4 |
| A6 | 60 | 300 | 5 |

It can be seen that at particularly low impact frequencies f, the ratio is slightly increased. In this case, even at low impact frequencies f, this enables a rock that is to be processed to be crushed evenly.

A particularly energy-saving operation arises at medium impact frequencies f.

By contrast, in the range of high crushing capacities, that is to say at higher impact frequencies f, the ratio increases again.

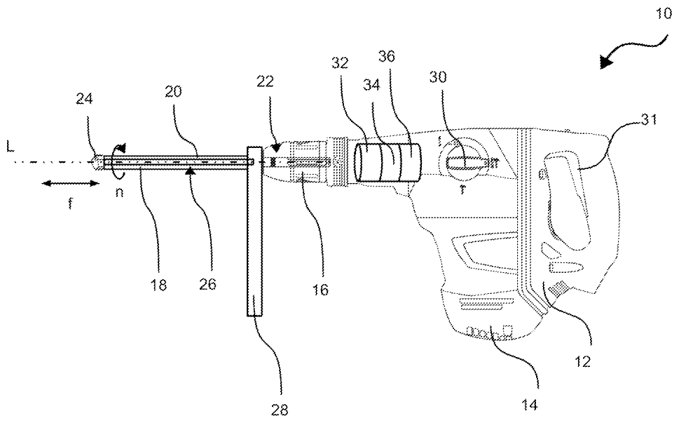

In order to be able to set these different ratios, the hand-held power tool 12 has a multi-stage transmission (not shown in FIG. 1). The transmission can, for example, have an overrunning clutch, a gate-type transmission or a circular thrust transmission in accordance with the European patent applications mentioned at the beginning and incorporated by reference.

1.-12. (canceled)

13. A hand-held power tool (12), comprising:
a tool fitting (16);
an impact mechanism (32); and
a rotary drive (34);
wherein the hand-held power tool (12) is configured to rotate a tool (18) held in the tool fitting (16) with a rotational speed (n) about a longitudinal axis (L) of the tool (18) and to drive the tool (18) with an impact movement along the longitudinal axis (L) at an impact frequency (f) and wherein the impact mechanism (32) is a direct electromechanical, or an electropneumatic, or an electromagnetic impact mechanism;
wherein a ratio of the rotational speed (n) to the impact frequency (f) at least at a working point of the hand-held power tool (12) is at most 5.0 rpm/Hz; or
wherein at least at the working point of the hand-held power tool (12), the rotational speed (n) is at most (0.2*(f/Hz-22)\hat{ }2+80) rpm for impact frequencies (f) in a range from 20 to 60 Hz.

14. The hand-held power tool (12) as claimed claim 13, wherein the hand-held power tool (12) is a hammer drill.

15. The hand-held power tool (12) as claimed in claim 13, wherein the ratio of the rotational speed (n) to the impact frequency (f) at least at the working point of the hand-held power tool (12) is at most 4.0 rpm/Hz.

16. The hand-held power tool (12) as claimed in claim 13, further comprising at most one drive unit for driving the impact mechanism (32) and the rotary drive (34).

17. The hand-held power tool (12) as claimed in claim 13, further comprising a tool recognition device, wherein a type of tool (18) used in the tool fitting (16) is identifiable by the tool recognition device.

18. The hand-held power tool (12) as claimed in claim 13, wherein the hand-held power tool (12) is configured such that a type of the tool (18) is settable by a user of the hand-held power tool (12).

19. The hand-held power tool (12) as claimed in claim 13, wherein the hand-held power tool (12) has a multi-stage transmission.

20. The hand-held power tool (12) as claimed in claim 13, further comprising a pneumatic or an electropneumatic cuttings conveying device (28).

21. The hand-held power tool (12) as claimed in claim 13, wherein the hand-held power tool (12) is a portable device.

22. The hand-held power tool (12) as claimed in claim 13, wherein the hand-held power tool (12) is operatable cordlessly.

23. The hand-held power tool (12) as claimed in claim 22, wherein the hand-held power tool (12) has a lithium-containing battery.

24. The hand-held power tool (12) as claimed in claim 13, further comprising an overrunning clutch or a gate-type transmission or a circular thrust transmission.

25. A tool (18) for the hand-held power tool (12) as claimed in claim 13, comprising:
a tool tip (24);
a tool shaft (20); and
a shank (22), wherein the tool (18) is holdable in the tool fitting (16) of the hand-held power tool (12) by the shank (22);
wherein a material transport channel (26) is formed at least along the tool shaft (20) and wherein the material transport channel (26) has a minimum cross-sectional area of 19 mm² or at least 6% of a cross-sectional area of a borehole that is producible by the tool (18).

26. The tool (18) as claimed in claim 25, wherein the tool (18) is a suction drill.

27. A hand-held power tool system (10), comprising:
the hand-held power tool (12) as claimed in claim 13; and
the tool (18) as claimed in claim 25.
